(19) United States
(12) Patent Application Publication
(10) Pub. No.: US 2009/0145574 A1
(43) Pub. Date: Jun. 11, 2009

(54) SELF-ADJUSTING SEAL FOR A HEAT EXCHANGER

(76) Inventor: Frank Klisura, Corona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/951,255

(22) Filed: Dec. 5, 2007

(51) Int. Cl. F23L 15/02; B23P 15/26

(52) U.S. Cl. 165/8; 165/9; 29/890.034

(57) ABSTRACT

Disclosed is an improved sealing element for a regenerative heat exchanging apparatus, such as a Ljungstrom™-type or other suitable regenerative heat exchangers. The sealing element can be mounted to a wall of the rotor of the heat exchanger to provide a secure seal between the wall and a housing of the heat exchanger, thereby inhibiting the leakage of gas between the hot gas conduit and cool air conduit of the regenerative heat exchanger. In one embodiment, the sealing element includes a base plate that is used to mount the sealing element to the wall. The sealing element also includes a contact shoe that maintains a sealing contact between the wall and housing. A flexible portion is coupled between the base plate and contact shoe to provide the sealing element with flexibility and resiliency so that the sealing element maintains contact with the sealing surface even when the heat exchanging apparatus experiences warping and/or distortion from thermal stress. The stress from the deflection of the seal during operation of the heat exchanger is substantially concentrated in the flexible portion of the seal.

### BACKGROUND OF THE INVENTION

1. Field of the Invention

The present invention relates to heat exchange technology and, in particular, relates to a self-adjusting radial seal for a heat exchanger that may be used to reduce leakage between a hot gas conduit and a cold air conduit of a regenerative heat exchanging system.

2. Description of the Related Art

Conventional regenerative heat exchangers are used to provide preheated air to heavy machinery, such as a fuel burning power plant, and may be used with various types of machinery that exhaust hot gas and operate more efficiently when supplied with preheated air, such as, for example, chemical processors, refineries, pulp and paper mills, and ships. Typically, two fluid stream passages extend through the heat exchanger. The first passage may include a hot gas conduit that communicates with a hot exhaust outlet of the power plant. Hot exhaust gases flow from the power plant exhaust into the hot gas conduit of the heat exchanger. The second passage may include a cold air conduit that communicates with a cool air intake passage of the power plant. Cold air conduit feeds pressurized air into the intake passage of the power plant. As is known in the art, regenerative heat exchangers extract heat from the exhaust gases of the fuel burning power plant and transfer the heat to the cool air conduit.

As is also known in the art, leakage between the hot gas conduit and the cold air conduit reduces the thermal efficiency of heat exchangers. It is therefore desirable to provide a sealing mechanism between hot and cold conduits so that gas does not leak between the hot gas conduit and the cold air conduit. Therefore, seals may be mounted at the junctions between the movable heat exchanging body and the housing of the heat exchanging apparatus. Unfortunately, conventional seals have many disadvantages. For example, seals are typically exposed to harsh operating conditions, such as erosive fly ash and soot. As the heat exchanging body moves with respect to the housing or vice versa, the seals are also exposed to mechanical abuse because the seals are positioned to maintain sliding contact with the sealing surfaces. Consequently, the seals wear down quickly.

Further, the high operating temperatures of the heat exchanging apparatus expose the seals to thermal stresses which often cause the seals to warp. The high operating temperature also causes thermal distortions in the shape of the structural members of the heat exchanging apparatus, such as the housing and center shaft. The distortions in the shape of the seals and the structural members affect the clearance between the seals and the sealing surfaces, often resulting in leakage paths between the hot gas conduit and the cold air conduit. Such leakage paths typically reduce the thermal efficiency of the heat exchanging apparatus and also reduce the overall efficiency of the system.

Conventional seal designs do not adequately address these problems. Some seals are made from relatively thick metal which holds up well against corrosion and mechanical abuse. However, such seals are not very flexible and often lose contact with the sealing surface when the structural members of the heat exchanging apparatus thermally distort. Other seals are extremely flexible so that they initially offer better sealing characteristics by expanding or contracting when the structural members thermally distort to maintain contact with the sealing surface. However, such seals hold up poorly to corrosion and mechanical abuse.

Certain prior art seals have been equipped with flexible portions that allow the seal to flex in response to deformations in the heat exchanger. For instance, U.S. Pat. No. 5,950,707 discloses a seal having resilient components that allow for flexible deformations. However, such seals may fracture or break when flexibly responding to torque stress loads that are produced by rotation of the heat exchanging body with respect to the housing of the heat exchanger. As a result, stress fractures may allow gas leakage between conduits.

Therefore, there exists a need for an improved resilient seal that can be used in conjunction with heat exchanging systems to reduce the adverse effects of rotational stress loads so as to substantially reduce the likelihood of leakage between hot and cold conduits of the heat exchanger. An improved resilient seal that resists corrosion abuse, mechanical abuse, and thermal distortion of the structural components would be preferred over conventional seals that are typically associated with regenerative heat exchanging systems and technology.

### SUMMARY OF THE INVENTION

In accordance with one embodiment, a self-adjusting seal assembly for a regenerative heat exchanger having a housing and a heat exchanging body disposed within the housing is provided, where the heat exchanging body configured to rotate in a first direction relative to the housing, the seal assembly extending between the heat exchanging body and the housing and defining an interface therebetween. The seal assembly comprises a base plate removably coupleable to a wall of the heat exchanging body configured to rotate about an axis of the heat exchanging body. A flexible portion is disposed adjacent a portion of the base plate and is coupled to the base plate at desired intervals along their entire lengths, the flexible portion configured to extend between an edge of the wall and an inner surface of the housing. A contact plate is disposed adjacent a portion of the flexible portion and coupled to the flexible portion at desired intervals along their entire lengths, the contact plate configured to contact the housing as the heat exchanging body rotates to inhibit leakage of air between the heat exchanging body and the housing. At least one of the flexible portion and contact plate deflect in a second direction opposite the first direction such that a stress generated by said deflection is substantially concentrated in the flexible portion, said deflection adjusting automatically such that contact is maintained between the contact plate and the inner surface of the housing during operation of the regenerative heat exchanger.

In accordance with another embodiment, a regenerative heat exchanger is provided. The heat exchanger comprises a housing defining a first conduit and a second conduit, each of the first and second conduits configured to receive airflow therethrough and a heat exchanging body disposed within the housing, the heat exchanging body configured to rotate in a first direction relative to the housing so that portions of the heat exchanging body are alternatingly exposed to the first conduit and second conduit. The heat exchanger also comprises at least one seal extending between the heat exchanging body and the housing, the seal configured to contact the housing as the heat exchanging body rotates to inhibit leakage of air between the first and second conduits, the seal further configured to flex in a second direction opposite the first direction. The seal comprises a base plate removably coupleable to a wall of the heat exchanging body configured to rotate about an axis of the heat exchanging body and a flexible metal sheet disposed adjacent a portion of the base plate and coupled to the base plate at desired intervals along their entire lengths, the flexible metal sheet configured to extend between an edge of the wall and an inner surface of the housing. The seal also comprises a contact plate disposed adjacent a portion of the flexible metal sheet and coupled to the flexible metal sheet at desired intervals along their entire lengths, the contact plate configured to contact the housing as the heat exchanging body rotates to inhibit leakage of air between the heat exchanging body and the housing. At least one of the flexible metal sheet and contact plate deflect in a second direction opposite the first direction such that a stress generated by said deflection is substantially concentrated in the flexible metal sheet, said deflection adjusting automatically such that contact is maintained between the contact plate and the inner surface of the housing during operation of the regenerative heat exchanger

### BRIEF DESCRIPTION OF THE DRAWINGS

These and other objects and advantages of the present invention will become more fully apparent from the following description taken in conjunction with the accompanying drawings. The illustrations are intended to illustrate, but not to limit, the invention.

FIG. 1 is a schematic perspective view of one embodiment of a heat exchanger incorporating a self-adjusting seal assembly in accordance with one embodiment.

FIG. 2 is a schematic top view of the heat exchanger of FIG. 1.

FIG. 3 is a schematic cross-sectional side view of the heat exchanger of FIG. 1.

FIG. 4A is a schematic perspective view of one embodiment of the self-adjusting seal assembly.

FIG. 4B is a schematic front view of the seal assembly of FIG. 4A.

FIG. 4C is a schematic side view of the seal assembly of FIG. 4A.

FIGS. 5A and 5B are side views of the seal assembly of FIG. 4A mounted to a radial wall of the heat exchanger in FIG. 1.

### DETAILED DESCRIPTION OF THE PREFERRED EMBODIMENTS

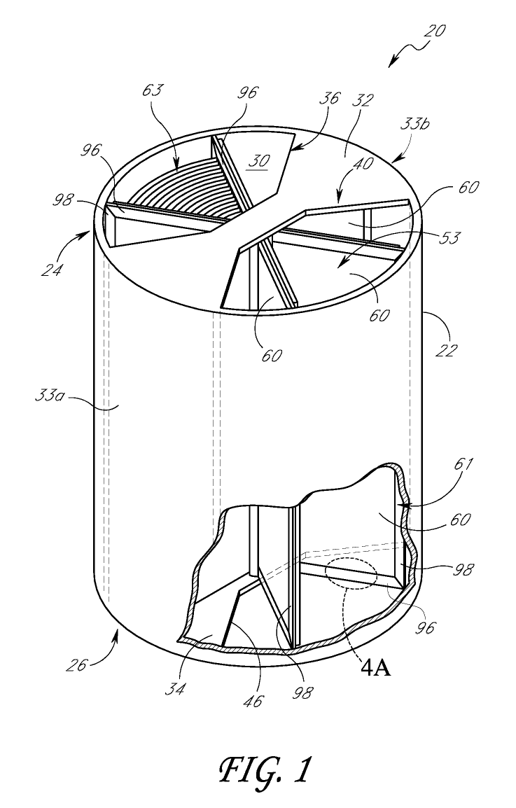

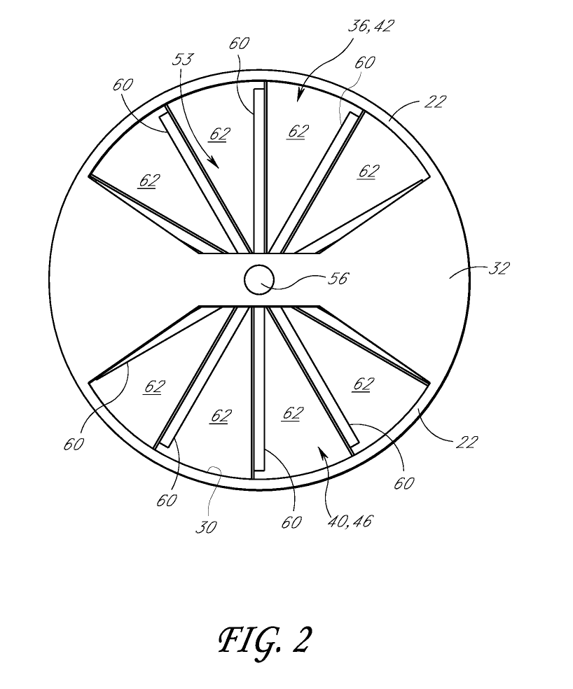

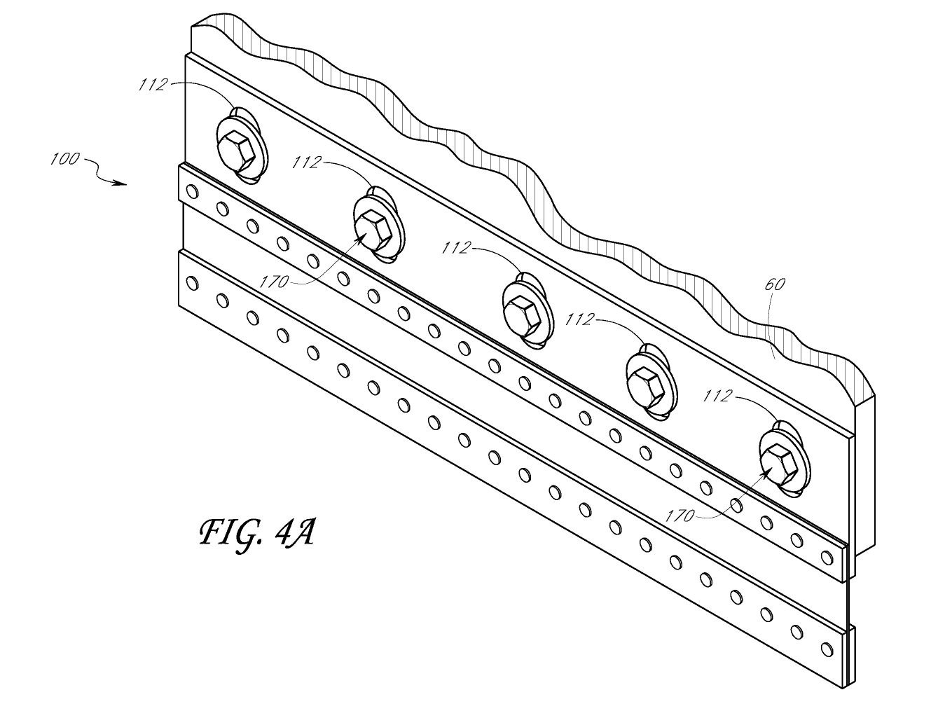

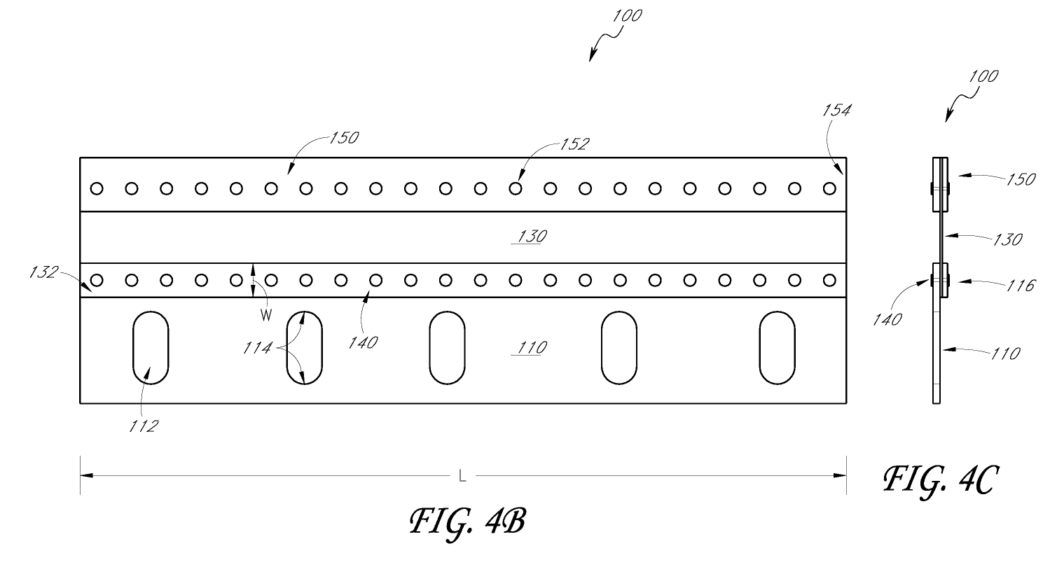

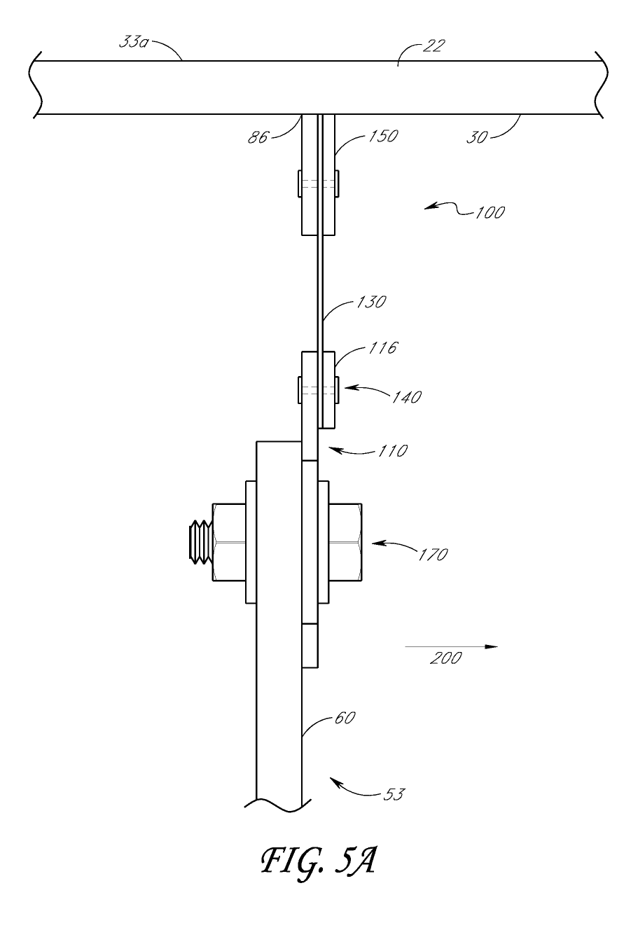

Reference will now be made to the drawings wherein like numerals refer to like parts throughout. FIG. 1 is a perspective view of one embodiment of a regenerative heat exchanging apparatus (or heat exchanger) 20 in which seal assemblies 96, 98 (shown in FIGS. 4A-4C) are used. FIG. 2 illustrates a top view of the heat exchanging apparatus 20 of FIG. 1. The heat exchanging apparatus 20 includes a housing 22 that can have a substantially cylindrical shape. The housing 22 has a top end 24 and a bottom end 26. As used herein, the words “top” and “bottom” are with respect to the drawings and are not intended to limit the scope of the invention. In one embodiment, the heat exchanging apparatus 20 can be a Ljungstrom™-type Air Preheater. However, the heat exchanging apparatus 20 can be any suitable regenerative heat exchanger (e.g., Rothemuhle®-type Regenerative Air Preheater). Further details on regenerative heat exchangers and associated members can be found in U.S. Pat. No. 5,950,707, issued Sep. 14, 1999, which is hereby incorporated by reference in its entirety and should be considered a part of this specification.

As illustrated in FIGS. 1 and 2, a movable heat exchanging body or rotor 53 is rotatably positioned within the housing 22. The heat exchanging rotor includes a rotatable center shaft 56 that is preferably aligned with the axial centerline of the housing 22. A plurality of radial walls 60 extend radially outward from the center shaft 56. A first seal assembly 96 (e.g., a radial seal) can be mounted along each of the top and bottom edges of the radial walls 60. A second seal assembly 98 (e.g., an axial seal) can be mounted on the outer radial edge 61 of each of the radial walls 60. The axial seals extend axially along the length of the housing 20.

In addition, the housing 22 has a side inner surface 30 that defines a hollow interior. The top and bottom ends 24, 26 of the housing 22 can include a top sector plate 32 and a bottom sector plate 34, respectively. The bottom sector plate 34 is preferably aligned with the top sector plate 32. Axial portions 33a and 33b of the housing 22 (indicated by dashed lines in FIG. 1) define axial sector plates of the assembly 20. The top sector plate 32, the bottom sector plate 34 and the axial sector plates 33a and 33b define the boundary, or interface, between the intake and outlet conduit of the regenerative air preheater.

In one aspect, the top sector plate 32 defines an intake or cool air aperture 36 that allows cool air to be passed into the interior of the heat exchanging apparatus 20. An exhaust hot gas aperture 40 is also defined by the top sector plate 32 for allowing hot gas to be passed out of the heat exchanging apparatus 20. The bottom sector plate 34 also defines an intake aperture 42 that is aligned below the intake aperture 36. An exhaust aperture 46 on the bottom end 26 is aligned directly below the exhaust aperture 40. Those skilled in the art will appreciate that the location of the inlets and outlets of the heat exchanging apparatus 20 may be reversed without departing from the scope of the present invention. Furthermore, the axis of the heat exchanging apparatus 20 is not limited to a vertical orientation as shown in FIG. 1, but could also be oriented horizontally or at any of a wide variety of orientations.

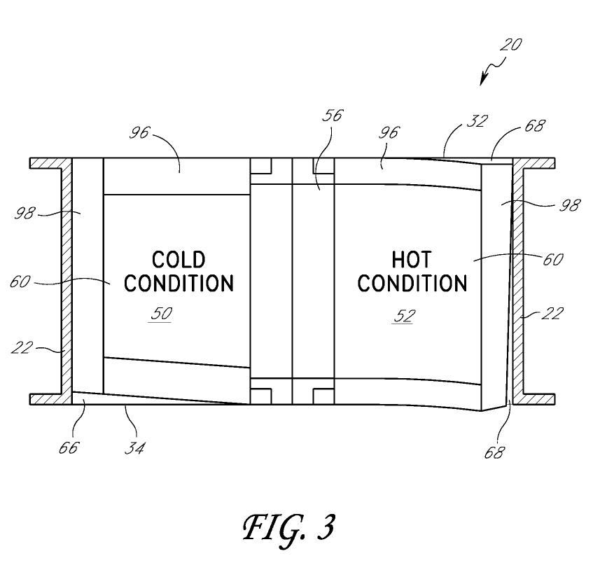

The interior volume of the housing 22 between the top intake aperture 36 and bottom intake aperture 42 defines an intake conduit 50 (FIG. 3). During operation of the heat exchanging apparatus 20, air is fed through the intake conduit 50 into a power plant (not shown), as described below. Similarly, the top exhaust gas aperture 40 and the bottom exhaust aperture 46 collectively define an exhaust conduit 52 therebetween that extends within the interior of the housing 22 from the top to the bottom of the heat exchanging apparatus 20. Hot exhaust gases are fed from the power plant through the exhaust conduit 52 during operation of the heat exchanging apparatus, as described below.

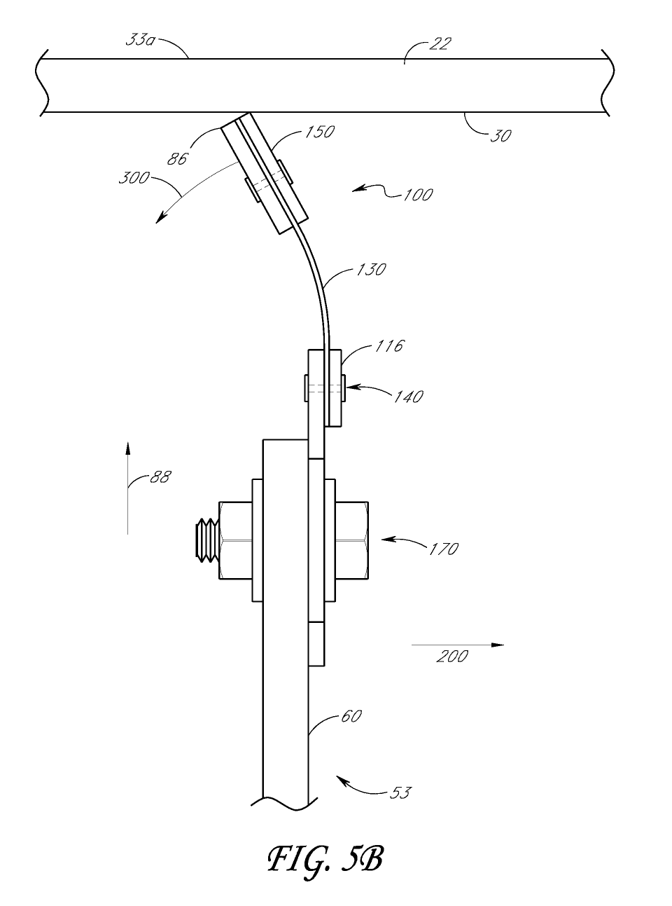

In one embodiment, the radial seals 96 are positioned on the radial walls 60 so that the outer edges of the radial seals 96 contact the inner surfaces of the sector plates 32 and 34 when the radial walls 60 are positioned between the sector plates 32 and 34 in the manner shown in greater detail in reference to FIGS. 5A and 5B. In this manner, the radial seals 96 provide a seal between the intake conduit 50 and the exhaust conduit 52, as described below. In addition, the axial seals 98 may be positioned such that the outer edges of the axial seals 98 contact the side inner surface 30 of the axial sector plates 33a and 33b. Advantageously, the axial seals 98 reduce leakage around the circumference of the housing 22 between the outer radial edges of the radial walls 60 and the side inner surface 30 of the axial sector plates 33a and 33b that divide the exhaust conduit 52 from the inlet conduit 50.

As further illustrated in FIG. 2, the radial walls 60 define a plurality of angular sectors 62 within the heat exchanging rotor 53. The angular sectors 62 extend from the top end 24 to the bottom end 26 of the heat exchanging apparatus 20 and communicate at either end with intake apertures 36, 42 and exhaust apertures 40, 46. Interposed between each radial wall 62 is a core sector 63. The core sector 63 may comprise of thin corrugated metal that is capable of absorbing heat from the exhaust of the power plant and then transferring this heat to the cool air in the intake conduit 50 in a manner that will be described in greater detail below. For ease of illustration, the core sector 63 is shown in only one angular sector 62 (see FIG. 1). In one embodiment, a core sector 63 can be positioned in each of the angular sectors 62.

During operation of the heat exchanging apparatus 20 as a Ljungstrom™-type Air Preheater, the heat exchanging rotor 53 rotates about the center shaft 56 within the housing 22. As the heat exchanging rotor 53 rotates, the angular sectors 62 are alternately aligned with the cool air intake conduit 50 and the hot gas exhaust conduit 52. When aligned with the intake conduit 50, the tops and bottoms of the angular sectors 62 communicate with the top and bottom intake apertures 36 and 42, respectively. Similarly, when aligned with the exhaust conduit 52, the tops and bottoms of the angular sectors 62 communicate with the exhaust apertures 40 and 46. The angular sectors 62 thus function as passageways through which cool air or hot gas flows.

The heat exchanging apparatus 20 functions as a Ljungstrom™-type Air Preheater as follows. One end of the intake conduit 50 is connected to a supply of intake gas, such as air. The other end of the intake conduit 50 is connected to a destination location, such as the cool air inlet passage of a power plant (not shown). The exhaust conduit 52 is also connected to the destination location, such as a hot gas exhaust outlet of the power plant. Any type of piping or duct work known to those skilled in the art may be used to connect the power plant and air supply to the heat exchanging apparatus 20.

In one embodiment air can flow into the intake conduit 50 via the top intake aperture 36. The air flows through the particular angular sector 62 that is aligned with the intake conduit 50. The air then flows out of the heat exchanging apparatus 20 through the bottom intake aperture 42 and into the cool air intake passage of the power plant. The power plant exhausts hot gases into the hot gas conduit 52 through the bottom exhaust aperture 46. The hot gases pass through the particular angular sector 62 that is aligned with the exhaust conduit 52. The hot gases then flow out of the heat exchange apparatus 20 through the top exhaust aperture 40.

In one embodiment, the heat exchanging body 53 can continually rotate within the housing 22 as the above-described process occurs. Thus, each angular sector 62 alternately aligns with the cool air intake conduit 50 and the hot gas exhaust conduit 52 as the heat exchanging rotor 53 rotates. That is, the angular sectors 62 are cyclically exposed to the intake conduit 50 and the exhaust conduit 52. When a particular angular sector 62 is located between the sector plates 32 and 34, the radial seals 96 contact the inner surfaces of the sector plates 32, 34 to prevent leakage between the exhaust conduit 52 and the intake conduit 50. Similarly, the axial seals 98 contact the side inner surface of the axial sector plates 33a and 33b to prevent leakage around the circumference of the housing 22 between the exhaust conduit 52 and intake conduit 50.

When an angular sector 62 aligns with the exhaust conduit 52, the core material 63 in the angular sector 62 absorbs heat from the exhaust gas in a well known manner. The heat exchanging body 53 continues to rotate so that the particular angular sector 62 eventually becomes aligned with the cool air conduit 50. The heat collecting core 63 then releases heat into the air flowing through the cool air conduit 52 to thereby warm the air.

The heat exchanging apparatus 20 can also be used to illustrate the basic operation of other regenerative heat exchangers (e.g., a Rothemuhle®-type Regenerative Air Preheater). The basic structure in this type of preheater is similar to the structure in a Ljungstrom™-type preheater. However, in a Rothemuhle®-type Regenerative Air Preheater the heat exchanging body 53 is fixed and the housing 22 rotates about the center shaft 56. Alternatively, a portion of the housing 22 or the duct work connecting the heat exchanger 20 to the power plant and air supply could rotate. In a Rothemuhle®-type preheater, the intake conduit 50 and exhaust conduit 52 rotate with respect to the heat exchanging body so that the angular sectors 62 are cyclically exposed to hot exhaust gases and cool air.

In both embodiments of regenerative air preheater, the heat exchanging apparatus 20 transfers heat from the hot exhaust gases of the power plant to the cool air that is being supplied to the power plant. This increases the operating efficiency of the power plant.

FIG. 3 is a schematic side view of the heat exchanging apparatus 20 illustrating the thermal deformations that the structural members of the heat exchanging apparatus 20 undergo during operation. The transfer of heat from the hot gas conduit 52 to the cool air conduit 50 creates temperature gradients throughout the heat exchanging apparatus 20. These temperature gradients cause thermal distortions that may affect the shapes of the structural members, including the center shaft 56, the radial walls 60, the radial seals 96, and the axial seals 98. It should be appreciated that the thermal distortions of the various components of the heat exchanging apparatus 20 can affect the clearance between seals 96, 98 mounted to the heat exchanger and the sealing surfaces (i.e., the inner surfaces of the sector plates).

As is shown in FIG. 3, the thermal gradients within the heat exchanging apparatus 20 can cause the structural components of the heat exchanging apparatus 20 to warp in shape. The left side of the heat exchanging apparatus in FIG. 3 illustrates the shape of the various structural components of the heat exchanging apparatus in an initial cold condition. As shown, a clearance gap 66 is often provided to compensate for the structural distortion that occurs during operation. The right side illustrates the shape of the heat exchanging apparatus in a hot condition. As shown, the thermal distortion causes the radial and axial seals 96, 98 to move away from the housing 22 of the heat exchanging apparatus and create leakage gaps 68 between the seals 96, 98 and the housing 22. Consequently, gas leaks between the hot gas conduit 52 and the cool air conduit 50 through the leakage gaps 68. This is highly undesirable as it reduces the thermal efficiency of the heat exchanging apparatus 20.

FIGS. 4A-4C illustrates one embodiment of an improved self-adjusting seal 100, which can be coupled to the radial walls 60 of the heat exchanging body 53 to operate as the radial and axial seal assemblies 96, 98, as described above. In the illustrated embodiment, the self-adjusting seal 100 includes a base plate 110, a flexible portion 130 and a contact shoe 150. The base plate 110 can be removably coupled to one of the walls 60 proximal an edge (such as the radial or top/bottom edges) thereof and extend along substantially along the entire length of said edge. For example, the base plate 110 can include a plurality of apertures 112 through which fasteners 170 (e.g., bolts) can be inserted to mount the base plate 110 adjacent the wall 60. In one embodiment, the apertures 112 are elongated (e.g., oval) with a major dimension 114 that is larger than a diameter of the fastener that extends through the aperture 112, so that the base plate 110 can be secured in a plurality of positions relative to the wall 60 based on where along the major dimension 114 of the apertures 112 the fasteners are attached. However, the apertures 112 can have other suitable shapes, such as round.

As shown in FIGS. 4A-4C, the base plate 110 is attached to the flexible portion 130 along a length L of an interface 132 between the base plate 110 and the flexible portion 130. In one embodiment, the interface 132 can have a length L of between about 20 inches and about 50 inches and a width W of between about 0.1 inch and about 2 inches. However, the interface 132 can have other dimensions. The base plate 110 can be attached to the flexible portion 130 by a plurality of fasteners 140 spaced at desired intervals along the length L. Said plurality of fasteners 140 attaches the base plate 110 to the flexible portion 130 substantially rigidly to inhibit detachment of the base plate 110 from the flexible portion 130. In the illustrated embodiment, the fasteners 140 fasten the flexible portion 130 between the base plate 110 and a support plate 116 that extends along the interface 132. As shown in FIGS. 4A-4C, the fasteners 140 can be rivets, which can be made of steel or other suitable metals or metal alloys. The fasteners 140 can be spaced apart from each other by between about 0.2 inches and about 2 inches. In another embodiment, the fasteners 140 can be spaced apart by more than about 2 inches. However, the fasteners 140 are not limited to the rivets shown in the illustrated embodiment, and other suitable mechanical fasteners can be used (e.g., bolts, clamps, etc.).

In one embodiment, the flexible portion 130 can be a planar sheet portion made of metal, such as 321 annealed steel. However, other suitable spring steels, or other suitable materials, can be used. In the illustrated embodiment, the thickness of the flexible portion 130 is significantly smaller than the thickness of the base plate 110. For example, the base plate 110 can be between about 1.5 to about 3 times thicker than the flexible portion 130 to provide mechanical strength to the seal 100 against warping and distortion.

In one embodiment, the base plate 110 can have a thickness of between about 0.01 inches and about one inch, and more preferably between about 0.08 inches and about 0.15 inches. However, the base plate 110 can have other thicknesses, such as a thickness greater than one inch.

In addition, the flexible portion 130 can preferably flex, compress and expand in a manner that allows the flexible portion 130 to function as a spring. In one aspect, the flexible portion 130 can adapt to the effects of operating conditions, such as expansion from heat, so that it compresses and deforms in the same manner that a spring compresses and deforms. Additionally, when the operating condition is removed, the flexible portion 130 can preferably recover to its original shape in a manner similar to a spring.

As illustrated in FIGS. 4A and 4B, the flexible portion 130 can have a thickness of between about 0.02 inches and about 0.1 inches and a single layer of sheet material, such as steel or any of a wide variety of materials known to those skilled in the art. However, the flexible portion 130 may also have a thickness greater than those noted above, and can comprises a number of material layers of material joined together in any of a wide variety of manners. In one embodiment, the flexible portion 130 can have a thickness of between about 0.01 inches and about one inch, and more preferably between about 0.02 inches and about 0.08 inches. However, the flexible portion 130 can have other thicknesses, such as a thickness greater than one inch.

With continued reference to FIGS. 4A-4C, the flexible portion 130 can be coupled to at least one contact shoe 150, which comes in contact with the inner surface 30 of the housing 22 to provide a seal between sectors 62 adjacent the wall 60 to which the self-adjusting seal 100 is attached. In the illustrated embodiment, the flexible portion 130 is fastened between two contact shoes 150 via a plurality of fasteners 152 (e.g., rivets) spaced apart at desired intervals along the length of an interface 154 between the contact shoes 150 and the flexible portion 130. Said plurality of fasteners can attach the contact shoes 150 to the flexible portion 130 substantially rigidly to inhibit detachment of the contact shoes 150 from the flexible portion 130. In the illustrated embodiment, the fasteners 152 can be spaced apart at between about 0.2 inches and about 2 inches. However, other suitable spacing intervals can be used.

In the illustrated embodiment, the contact shoes 150 are plates of hardened metal (e.g., hardened steel). However, other materials suitable for providing seals between the heat exchanging body 53 and the housing 22 can be used. In the illustrated embodiment, the thickness of the flexible portion 130 is significantly smaller than the thickness of the contact shoe 150. For example, the contact shoe 150 can be between about 1.5 to about 3 times thicker than the flexible portion 130 to provide increased mechanical strength to the seal 100 against warping and distortion. In the illustrated embodiment, the two contact shoes 150 together have a thickness of between about 3 and 10 times the thickness of the flexible portion 130. However, other suitable relative thicknesses can be used. In one embodiment, each contact shoe 150 can have a thickness of between about 0.01 inches and about one inch, and more preferably between about 0.08 inches and about 0.15 inches. However, the contact shoe 150 can have other thicknesses, such as a thickness greater than one inch.

In one embodiment, the contact shoe 150 can have a substantially straight outer edge so as to seal the juncture between the inner surface 30 of the housing and the outer surface of the heat exchanging body or rotor 53.

FIGS. 5A and 5B show the self-adjusting seal 100 in a first position (FIG. 5A) when the heat exchanging body 53 (and therefore the wall 60 to which the seal 100 is coupled) are stationary and in a second position (FIG. 5B) when the heat exchanging body 53 is rotating in a direction 200 relative to the housing 22. As shown in FIG. 5A, the contact shoes 150 of the seal 100 are in contact with the inner surface 30 of the housing 22 such that the contact shoes 150 are oriented generally normal to the housing 22 at the point of contact and provide a seal that inhibits leakage of gas between sectors 62 of the heat exchanger 20. The contact shoes 150 of the seal 100 can be brought into contact with the housing 22 by adjusting the position of the seal 100 relative to the housing 22 (e.g., by sliding the seal 100 along the length of the apertures 112 until the desired position is achieved).

As the heat exchanging body 20 rotates (FIG. 5B), the contact shoes 150 remain in contact with the inner surface 30 of the housing 22, but the rotation of the heat exchanging body 20 in the direction 200 exerts a force on the contact shoes 150 in an opposite direction 300, which causes the contact shoes 150 to tilt in said opposite direction 300 and causes the flexible portion 130 to flex. Advantageously, the flexion force is substantially concentrated in the flexible portion 130 and transfer of the flexion force to the base plate 110 is inhibited. Accordingly, stress generated in the seal 100 from the rotation of the heat exchanging body 53 can advantageously be substantially concentrated in the flexible portion 130, which resiliently withstand the flexion while the seal 100 maintains contact with the inner surface 30 of the housing to inhibit leakage of gas between different sector s 62 of the heat exchanger 20, which provides for more efficient operation of the heat exchanger 20. Additionally, the seal 100 advantageously inhibits the concentration of stress in the base plate 110 attached to the wall 60 of the heat exchanging body 53, which might occur if the flexible portion and base plate portion of the seal were a unitary body, possibly leading to stress fractures in the base plate. In one embodiment, the flexible portion 130 is made of a resilient material that can yield, but not break, if the stress from the deflection of the flexible portion 130 exceeds a yield set point such that the contact shoe 150 can continue to maintain contact with the inner surface 30 of the housing 22.

Thus, the self-adjusting seal 100 advantageously provides an improved seal that provides a secure seal between the wall 60 and the housing 22 to reduce leakage between the hot gas conduit 52 and the cool air conduit 50 and a more durable seal design. The seal 100 also advantageously maintains a secure seal even when exposed to thermal distortion of the heat exchanging apparatus 20.

In addition, the seal 100 may also be resistant to the harsh operating conditions of the heat exchanging apparatus 20. It should be appreciated by one skilled in the art that the exact dimensions of the self-adjusting seal 100 may vary depending upon the specific application and use of the seal 100.

Although illustrated in FIG. 1 as being mounted to the radial wall 60, the seal assembly 96, 98 may also be mounted to the housing 22 in certain circumstances without departing from the scope of the invention. In such circumstances, the seal assembly 96, 98 seals between the housing 22 and the surface of the heat exchanging body 53.

As discussed above, the structural components of the heat exchanger 20 can undergo thermal distortion as a result of operational temperature gradients in the heat exchanger 20. Such temperature gradients cause the walls 60 to undergo thermal growth 88 (see FIG. 5B) and expansion toward the housing 22. Hence, the distance between the outer edge of the walls 60 and the inner surface 30 of the housing 22 decreases. Advantageously, the flexible portion 130 of the seal 100 can deflect as said distance decreases to maintain a seal that inhibits leakage of gas between the sectors 22 of the heat exchanger 20. As previously described, the flexible portion 100 can preferably compress and expand in a spring-like manner so as to adapt to harsh operating conditions and decrease the overall size of the seal 100. As a result, the flexible portion 130 allows the seal 100 to absorb the mechanical stresses created by the reduction in distance between the outer edge of the wall 60 and the inner surface 30 of the housing 22.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

What is claimed is:

1. A self-adjusting seal assembly for a regenerative heat exchanger having a housing and a heat exchanging body disposed within the housing, the heat exchanging body configured to rotate in a first direction relative to the housing, the seal assembly extending between the heat exchanging body and the housing and defining an interface therebetween, the seal assembly comprising:
a base plate removably coupleable to a wall of the heat exchanging body configured to rotate about an axis of the heat exchanging body;
a flexible portion disposed adjacent a portion of the base plate and coupled to the base plate at desired intervals along their entire lengths so that transfer of a stress force generated in the flexible portion to the base plate during operation of the heat exchanger is reduced, the flexible portion configured to extend between an edge of the wall and an inner surface of the housing; and
a contact plate disposed adjacent a portion of the flexible portion and coupled to the flexible portion at desired intervals along their entire lengths, the contact plate configured to contact the housing to inhibit leakage of air between the heat exchanging body and the housing,
wherein at least one of the flexible portion and contact plate deflect in a second direction opposite the first direction, said deflection adjusting automatically such that contact is maintained between the contact plate and the inner surface of the housing during operation of the regenerative heat exchanger.

2. The seal assembly of claim 1, wherein the housing is stationary and the heat exchanging body is configured to rotate relative to the housing.

3. The seal assembly of claim 1, wherein the flexible portion is a planar flexible sheet.

4. The seal assembly of claim 1, wherein the flexible portion is coupled to the base plate via a plurality of rivets.

5. The seal assembly of claim 1, wherein the contact plate is coupled to the flexible portion via a plurality of rivets.

6. The seal assembly of claim 1, wherein the flexible portion comprises a flexible metal sheet of 321 annealed steel.

7. The seal assembly of claim 1, wherein at least a portion of the flexible portion is disposed between the base plate and a support plate, the flexible portion riveted to the base plate and support plate at desired intervals along their respective lengths.

8. The seal assembly of claim 1, wherein the contact plate comprises two contact plates adjacent opposite sides of the flexible portion, the contact plates riveted to the flexible portion at desired intervals along their respective lengths.

9. The seal assembly of claim 1, wherein the flexible portion is configured to yield, but not break, if the stress from said deflection exceeds a yield set point such that the contact plate can continue to maintain contact with the inner surface of the housing.

10. A self-adjusting seal assembly for a regenerative heat exchanger having a housing and a heat exchanging body disposed within the housing, the heat exchanging body configured to rotate in a first direction relative to the housing, the seal assembly extending between the heat exchanging body and the housing and defining an interface therebetween, the seal assembly comprising:
a base plate removably coupleable to a wall of the heat exchanging body configured to rotate about an axis of the heat exchanging body;
a flexible portion disposed adjacent a portion of the base plate;
means for mechanically coupling the flexible portion to the base plate at desired intervals along their entire lengths so that transfer of a stress generated in the flexible portion to the base plate during operation of the heat exchanger is reduced, the flexible portion configured to extend between an edge of the wall and an inner surface of the housing; and
a contact plate disposed adjacent a portion of the flexible portion and coupled to the flexible portion at desired intervals along their entire lengths, the contact plate configured to contact the housing to inhibit leakage of air between the heat exchanging body and the housing,
wherein at least one of the flexible portion and contact plate deflect in a second direction opposite the first direction, said deflection adjusting automatically such that contact is maintained between the contact plate and the inner surface of the housing during operation of the regenerative heat exchanger.

11. The seal assembly of claim 10, wherein the housing is stationary and the heat exchanging body is configured to rotate relative to the housing.

12. A regenerative heat exchanger, comprising:
a housing defining a first conduit and a second conduit, each of the first and second conduits configured to receive airflow therethrough;
a heat exchanging body disposed within the housing, the heat exchanging body and housing configured to rotate relative to each other so that portions of the heat exchanging body are alternatingly exposed to the first conduit and second conduit;
at least one seal extending between the heat exchanging body and the housing, the seal configured to contact the housing to inhibit leakage of air between the first and second conduits, the seal further configured to flex in a second direction opposite the direction of relative movement of the heat exchanging body, the seal comprising
a base plate removably coupleable to a wall of the heat exchanging body configured to rotate about an axis of the heat exchanging body;
a flexible metal sheet disposed adjacent a portion of the base plate and coupled to the base plate at desired intervals along their entire lengths so that transfer of a stress generated in the flexible portion to the base plate during operation of the heat exchanger is reduced, the flexible metal sheet configured to extend between an edge of the wall and an inner surface of the housing; and
a contact plate disposed adjacent a portion of the flexible metal sheet and coupled to the flexible metal sheet at desired intervals along their entire lengths, the contact plate configured to contact the housing to inhibit leakage of air between the heat exchanging body and the housing,
wherein at least one of the flexible metal sheet and contact plate deflect in the second direction, said deflection adjusting automatically such that contact is maintained between the contact plate and the inner surface of the housing during operation of the regenerative heat exchanger.

13. The heat exchanger of claim 12, wherein said portions of the heat exchanging body are defined by walls that extend radially outward from an axis of rotation of the heat exchanging body.

14. The heat exchanger of claim 12, wherein the flexible metal portion is coupled to the base plate via a plurality of rivets.

15. The heat exchanger of claim 12, wherein the contact plate is coupled to the flexible metal portion via a plurality of rivets.

16. The heat exchanger of claim 12, wherein the flexible metal portion is configured to yield, but not break, if the stress from said deflection exceeds a yield set point such that the contact plate can continue to maintain contact with the inner surface of the housing.

17. The heat exchanger of claim 12, wherein the seal is at least one of a radial seal and an axial seal.

18. The heat exchanger of claim 12, wherein the housing is stationary and the heat exchanging body rotates relative to the housing.

19. A method of making a self-adjusting seal assembly for a regenerative heat exchanger having a housing and a heat exchanging body disposed within the housing, the heat exchanging body and housing configured to rotate relative to each other, the seal assembly extending between the heat exchanging body and the housing and defining an interface therebetween, the method comprising:
mechanically attaching a base plate to a planar flexible portion at desired intervals along their entire lengths so that transfer of a stress generated in the flexible portion to the base plate during operation of the heat exchanger is reduced, the base plate being removably coupleable to a wall of the heat exchanging body; and
mechanically attaching a contact plate to the planar flexible portion at desired intervals along their entire lengths at a location opposite the base plate, the contact plate configured to contact the housing to inhibit leakage of air between the heat exchanging body and the housing

20. The method of claim 19, wherein mechanically attaching the base plate to the planar flexible portion comprises riveting the base plate to the flexible portion at desired intervals along an interface between the base plate and the flexible portion.

21. The method of claim 19, wherein mechanically attaching the contact plate to the planar flexible portion comprises riveting the contact plate to the flexible portion at desired intervals along an interface between the contact plate and the flexible portion.
